(19) United States
(12) Patent Application Publication
(10) Pub. No.: US 2023/0200507 A1
(43) Pub. Date: Jun. 29, 2023

(54) ULTRA-THIN SUPPORT

(71) Applicants: Shenzhen Bashidehen Technology Co., Ltd, Shenzhen (CN); Chongqing Shiweixun Cultural Communication Co., Ltd, Chongqing (CN)

(72) Inventor: Xiangchao Chen, Shenzhen (CN)

(21) Appl. No.: 18/057,766

(22) Filed: Nov. 22, 2022

Related U.S. Application Data
(63) Continuation of application No. PCT/CN2022/099189, filed on Jun. 16, 2022.

(30) Foreign Application Priority Data
Dec. 25, 2021 (CN) 202123293071.X

(51) Int. Cl. A45C 11/00; F16M 13/00

(52) U.S. Cl. CPC A45C 11/00; F16M 13/005; A45C 2011/002; A45C 2200/15

(57) ABSTRACT

An ultra-thin support includes a support body, the support body includes a support base, an upper end of one side of the support base is integrally formed with a limiting platform, one end of the limiting platform is connected with a support column through a connecting strap, an upper end of the support column is connected with an upper mounting plate through a second connecting strap, an upper end of the upper mounting plate is adhered and fixed to a positioning support, a positioning hole is provided through a middle portion of the support base, a connecting portion of the limiting platform and the support column is integrally formed on the limiting platform with a positioning snap head, a positioning snap groove that matches with the positioning snap head is provided on an opposite end of the support column.

### CROSS REFERENCE TO RELATED APPLICATIONS

The present application is a Continuation Application of PCT Application No. PCT/CN2022/099189 filed on Jun. 16, 2022, which claims the benefit of Chinese Patent Application No. 202123293071.X filed on Dec. 25, 2021. All the above are hereby incorporated by reference in their entirety.

### TECHNICAL FIELD

The present utility model belongs to the technical field of peripheral accessories of mobile phones, in particular to an ultra-thin support.

### BACKGROUND TECHNOLOGY

A hand phone, belonging to a mobile terminal, is a mobile phone that can be held in the hands. In the early days, it was commonly known as Big Brother because of its large size. Currently, it has developed into a 5G era until now, mobile phones have become a very important tool in people’s lives, and have brought people with a better life experience. A mobile phone support is required for supplementary support during daily use of a mobile phone.

The current mobile phone support can support a mobile phone, and is convenient for a user to watch movies and videos, however, a mobile phone support which is not directly combined with a mobile phone is large in size, and as a whole is inconvenient to carry; for a support that is directly combined with a mobile phone, since as a whole a large portion is protruding, it will give a user a bad experience of use when the support is not in use, so it cannot satisfy different needs of the user.

### SUMMARY

The purpose of the present utility model is to provide an ultra-thin support in order to solve the above-mentioned problems.

The technical solution adopted by the present utility model is as follows: an ultra-thin support includes a support body, the support body includes a support base, an upper end of one side of the support base is integrally formed with a limiting platform, one end of the limiting platform is connected with a support column through a connecting strap, an upper end of the support column is connected with an upper mounting plate through a second connecting strap, an upper end of the upper mounting plate is adhered and fixed to a positioning support, a positioning hole is provided through a middle portion of the support base, a connecting portion of the limiting platform and the support column is integrally formed on the limiting platform with a positioning snap head, a positioning snap groove that matches with the positioning snap head is provided on an opposite end of the support column.

In a preferred embodiment, the support base is provided with a magnet ring when the support base is magnetically held to a mobile phone, and the support base as a whole is in a shape of a disc.

In a preferred embodiment, the limiting platform and the support column have a same thickness, a lower end of the positioning support is integrally formed with a positioning engagement point, the positioning support is engaged with and installed on the support base through cooperation of the positioning engagement point and the positioning hole.

In a preferred embodiment, the positioning support and the support base have a same shape, and the positioning support is smaller in size than the support base.

In a preferred embodiment, when the support base is fixed to a mobile phone case, a bottom end of the support base is integrally formed with and fixed to a rear face of the mobile phone case.

In a preferred embodiment, when the support base is fixed to a mobile phone snap cover, a bottom end of the support base is integrally formed with and fixed to a rear face the mobile phone snap cover, and the mobile phone snap cover is provided with a placement cavity in which the entire support body is placed.

In summary, in view of the adoption of the above-mentioned technical solution, the beneficial effects of the present utility model are:

1. In daily use, the positioning support is engaged and installed on the outside of the support base, the overall protruding portion is relatively small and the thickness is thinner, which can satisfy daily use when the positioning support is not required, when the positioning support is pulled out and the support column is lifted, then the lower end of the positioning support is engaged in the positioning hole, the fixing of the positioning support is completed, at this time, the positioning support provides supplementary support to the mobile phone, so that the overall usage effect is better.

2. In the present utility model, the device can be applied to the mobile phone itself, as well as to an assembled mobile phone case and a mobile phone snap cover, so that the overall applicability is stronger.

### DESCRIPTION OF THE DRAWINGS

FIG. 1 is a schematic diagram of a three-dimensional structure of the entire utility model;

FIG. 2 is a schematic diagram of an exploded three-dimensional structure of a support body of the present utility model;

FIG. 3 is a schematic diagram of a three-dimensional structure of the support body of the present utility model connected with a mobile phone case when in use;

FIG. 4 is a schematic diagram of a three-dimensional structure of the support body of the present utility model connected with the mobile phone case; and

FIGS. 5 and 6 are schematic diagrams of the three-dimensional structure of the support body of the present utility model connected with a mobile phone snap cover when in use.

Symbols in the drawings: 1 - support body, 11 - positioning support, 12 - support column, 13 - limiting platform, 14 - support base, 15 - positioning hole, 16 - upper mounting plate, 17 - positioning snap groove, 18 - positioning snap head, 2 - mobile phone snap cover, 3 - mobile phone case.

### DETAILED EMBODIMENTS

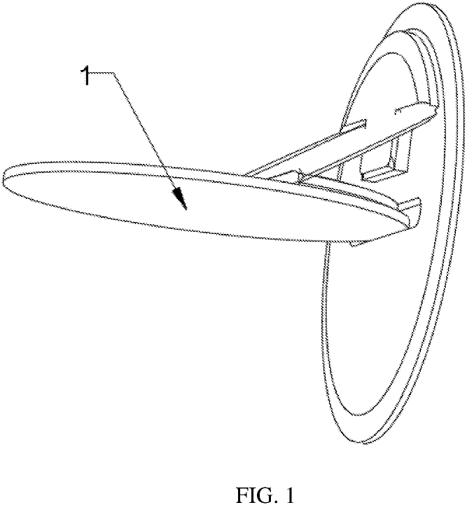

The present application will be further described in detail below in conjunction with FIGS. 1-6 in the accompanying drawings.

### Embodiment 1

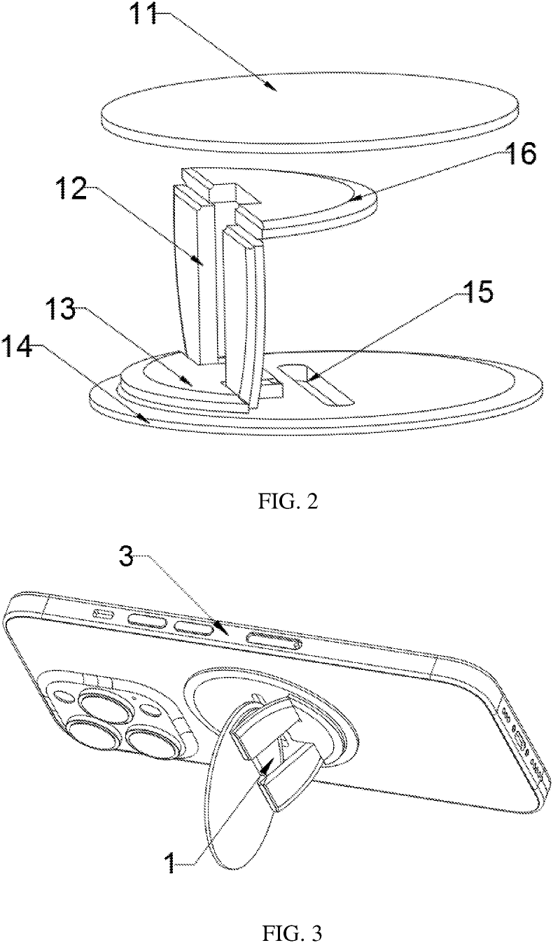

The present application discloses an ultra-thin support. Referring to FIG. 1 - FIG. 2, the ultra-thin support includes a support body 1, the support body 1 includes a support base 14, an upper end of one side of the support base 14 is integrally formed with a limiting platform 13, one end of the limiting platform 13 is connected with a support column 12 through a connecting strap, an upper end of the support column 12 is connected with an upper mounting plate 16 through a second connecting strap, an upper end of the upper mounting plate 16 is adhered and fixed to a positioning support 11, a positioning hole 15 is provided through a middle portion of the support base 14, the positioning support 11 is pulled out, the support column 12 is lifted up, and the lower end of the positioning support 11 is engaged in the positioning hole 15 to complete the fixing of the positioning support 11, at this time, supplementary support of the mobile phone can be carried out by the positioning support 11.

A connecting portion of the limiting platform 13 and the support column 12 is integrally formed on the limiting platform 13 with a positioning snap head 18, a positioning snap groove 17 that matches with the positioning snap head 18 is provided on an opposite end of the support column 12, the cooperation of the snap head 18 and the snap groove 17 can play a supplementary fixation effect of the support column 12 on the support base 14.

The support base 14 is provided with a magnet ring when the support base 14 is magnetically held to a mobile phone, the support base 14 as a whole is in a shape of a disc, the support body 1 is magnetically held to the rear end of the mobile phone by the magnet ring in the support base 14, the assembly with the mobile phone is completed, hence, it is more convenient to assemble with the mobile phone, instead of the method of fixing with a double-sided adhesive.

The limiting platform 13 and the support column 12 have the same thickness, a lower end of the positioning support 11 is integrally formed with a positioning engagement point, the positioning support 11 is engaged with and installed on the support base 14 through cooperation of the positioning engagement point and the positioning hole 15, the positioning support 11 is engaged with and installed on the outer side of the support base 14, the overall protruding portion is relatively small, which can meet the daily use when the positioning support 11 is not required.

The positioning support 11 and the support base 14 have the same shape, and the positioning support 11 is smaller in size than the support base 14.

The implementation principle of the ultra-thin support of the present application is as follows: before the device is used in daily life, the support body 1 is magnetically held on the rear end of a mobile phone through the magnet ring provided in the support base 14, the assembly with the mobile phone is completed, in daily use, the positioning support 11 is engaged with and installed on the outer side of the support base 14, and the overall protruded portion is relatively small, which can satisfy daily use when the positioning support 11 is not needed.

When the positioning support 11 needs to be used, the positioning support 11 is pulled out, the support column 12 is lifted, and the lower end of the positioning support 11 is engaged in the positioning hole 15 to complete the fixing of the positioning support 11, at this time, the positioning support 11 can assist in supporting the mobile phone.

### Embodiment 2

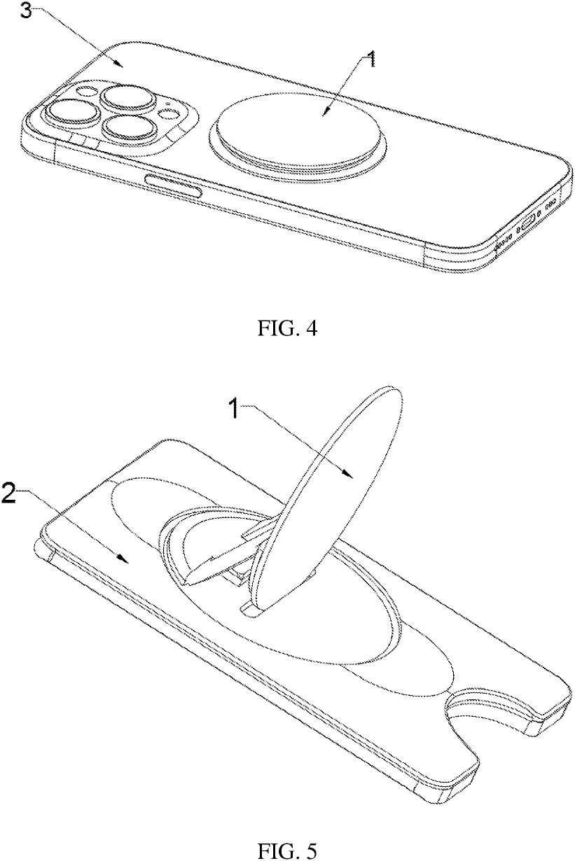

Referring to FIG. 3-FIG. 4, when the support base 14 is fixed to a mobile phone case 3, a bottom end of the support base 14 is integrally formed with and fixed to a rear face of the mobile phone case 3, the support body and the mobile phone case are integrally combined together, so that when the mobile phone case is used at the same time, the function of the support can also be performed, so that the overall applicability is stronger.

### Embodiment 3

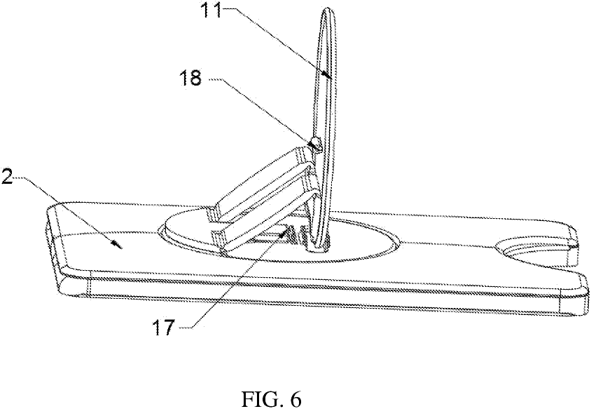

Referring to FIGS. 5 and 6, when the support base 14 is fixed to a mobile phone snap cover 2, a bottom end of the support base 14 is integrally formed with and fixed to a rear face the mobile phone snap cover 2, the mobile phone snap cover 2 is provided with a placement cavity in which the entire support body 1 is placed, the support body and the mobile phone snap cover are integrally combined together, so that when the mobile phone snap cover is used at the same time, the function of the support can also be performed, making it more practical as a whole.

It should be noted that, in this document, the relational terms such as “first” and “second” are only used to distinguish one entity or operation from another entity or operation, and do not necessarily require or imply any actual relationship or sequence existing between these entities or operations. Moreover, the term “comprising”, “including”, or any other variation thereof is intended to cover non-exclusive inclusion, such that a process, method, article or device that includes a list of elements includes not only those elements, but also includes other elements that are not explicitly listed, or other elements inherent to such process, method, article or device. Without further limitation, an element defined by the phrase “comprising a...” does not preclude the presence of additional equivalent elements in the process, method, article, or device that includes that element.

The above embodiments are only used to illustrate the technical solutions of the present utility model, but not to limit them; although the present utility model has been described in detail with reference to the above embodiments, those of ordinary skill in the art should understand that: the technical solutions disclosed in the above embodiments can still be modified, or some technical features thereof can be equivalently replaced; and this modification or replacement does not make the essence of the relevant technical solutions deviate from the spirit and scope of the technical solutions of the embodiments of the present utility model.

What is claimed is:

1. An ultra-thin support, comprising a support body, characterized in that: the support body comprises a support base, an upper end of one side of the support base is integrally formed with a limiting platform, one end of the limiting platform is connected with a support column through a connecting strap, an upper end of the support column is connected with an upper mounting plate through a second connecting strap, an upper end of the upper mounting plate is adhered and fixed to a positioning support, a positioning hole is provided through a middle portion of the support base, a connecting portion of the limiting platform and the support column is integrally formed on the limiting platform with a positioning snap head, and a positioning snap groove that matches with the positioning snap head is provided on an opposite end of the support column.

2. The ultra-thin support according to claim 1, characterized in that: the support base is provided with a magnet ring when the support base is magnetically held to a mobile phone, and the support base as a whole is in a shape of a disc.

3. The ultra-thin support according to claim 1, characterized in that: the limiting platform and the support column have a same thickness, a lower end of the positioning support is integrally formed with a positioning engagement point, and the positioning support is engaged with and installed on the support base through cooperation of the positioning engagement point and the positioning hole.

4. The ultra-thin support according to claim 1, characterized in that: the positioning support and the support base have a same shape, and the positioning support is smaller in size than the support base.

5. The ultra-thin support according to claim 1, characterized in that: when the support base is fixed to a mobile phone case, a bottom end of the support base is integrally formed with and fixed to a rear face of the mobile phone case.

6. The ultra-thin support according to claim 1, characterized in that: when the support base is fixed to a mobile phone snap cover, a bottom end of the support base is integrally formed with and fixed to a rear face the mobile phone snap cover, and the mobile phone snap cover is provided with a placement cavity in which the entire support body is placed.
